(19) United States
(12) Patent Application Publication
(10) Pub. No.: US 2025/0215652 A1
(43) Pub. Date: Jul. 3, 2025

(54) POWER TOOL

(71) Applicant: Nanjing Chervon Industry Co., Ltd., Nanjing (CN)

(72) Inventors: Chen Chen, Nanjing (CN); Toshinari Yamaoka, Nanjing (CN)

(21) Appl. No.: 18/938,536

(22) Filed: Nov. 6, 2024

(30) Foreign Application Priority Data
Dec. 27, 2023 (CN) 202311838640.5
Dec. 27, 2023 (CN) 202323596144.1
Dec. 27, 2023 (CN) 202323602873.3

(51) Int. Cl. E01H 5/09; B25F 5/02

(52) U.S. Cl. CPC E01H 5/098; B25F 5/02

(57) ABSTRACT

A power tool includes: an operation portion including a first handle for a user to grip; a working head drivable to work; a connecting rod connecting the first handle to the working head; and a battery pack configured to power the power tool. The first handle is disposed at the rear end of the connecting rod, and the first handle and the battery pack are disposed vertically along a direction perpendicular to the axis of the connecting rod. When an included angle between the axis of the connecting rod and a walking direction of the power tool is 45 degrees, an extension direction of the first handle forms a first included angle with the walking direction of the power tool, wherein the first included angle is greater than or equal to 30 degrees and less than or equal to 90 degrees.

### RELATED APPLICATION INFORMATION

This application claims the benefit under 35 U.S.C. § 119 (a) of Chinese Patent Application No. 202311838640.5, filed on Dec. 27, 2023, Chinese Patent Application No. 202323602873.3, filed on Dec. 27, 2023, and Chinese Patent Application No. 202323596144.1, filed on Dec. 27, 2023, which applications are incorporated herein by reference in their entireties.

### TECHNICAL FIELD

The present application relates to the technical field of tools and, in particular, to a power tool.

### BACKGROUND

Power tools are more environmentally friendly than engine-powered tools, leading to wide use of the power tools. For example, a snowfall causes snow accumulation in yards and on roads, making travel and activities inconvenient for people. The removal of the snow with shovels and brooms is too inefficient. Snow on an arterial road is generally removed by snow removal equipment. Existing snow removal equipment generally shovels up the snow with its snow shovel and rotates the auger to throw the shoveled-up snow outside. The auger is generally configured to be spiral, causing the shoveled-up snow to accumulate at the roadside.

Currently, a handle of a snow shovel is not in accord with use habits of users. It is inconvenient for a user to push and use the snow shovel to remove snow. Additionally, the snow shovel is relatively heavy, so it is more laborious for the user to use the snow shovel for a long period of time.

This part provides background information related to the present application, and the background information is not necessarily the existing art.

### SUMMARY

A power tool includes: an operation portion including a first handle for the user to grip; a working head drivable to work; a connecting rod connecting the first handle to the working head; and a battery pack configured to power the power tool. The first handle is disposed at the rear end of the connecting rod, and the first handle and the battery pack are disposed vertically along a direction perpendicular to the axis of the connecting rod. When an included angle between the axis of the connecting rod and a walking direction of the power tool is 45 degrees, an extension direction of the first handle forms a first included angle with the walking direction of the power tool, wherein the first included angle is greater than or equal to 30 degrees and less than or equal to 90 degrees.

In some examples, a lower edge of the first handle forms a second included angle with the axis of the connecting rod, where the second included angle is greater than or equal to 45 degrees and less than or equal to 90 degrees.

In some examples, the first handle further includes a grip trigger, and the height difference between the central position of the grip trigger and the axis of the connecting rod is less than or equal to 200 mm.

In some examples, the center of a grip of the first handle is disposed on the upper side of the axis of the connecting rod, and the battery pack is disposed on the lower side of the axis of the connecting rod.

In some examples, the battery pack is detachably connected to the connecting rod and is mounted to the connecting rod along a direction parallel to the connecting rod.

In some examples, the battery pack has a first length parallel to the connecting rod and a second length perpendicular to the connecting rod, where the first length is greater than the second length.

In some examples, the power tool further includes a second handle disposed on the upper side of the connecting rod.

In some examples, the second handle is disposed between the first handle and the working head, and when the included angle between the axis of the connecting rod and the walking direction of the power tool is 45 degrees, the height difference between the second handle and the central position of the first handle is less than or equal to 200 mm.

In some examples, the operation portion further includes a speed adjustment assembly configured to adjust a working speed of the power tool.

In some examples, when the power tool is placed on the ground with the working head and the battery pack both touching the ground, the battery pack forms a third included angle with the ground, where the third included angle is less than or equal to 30 degrees.

In some examples, the connecting rod includes a first connecting rod connected to the working head and a second connecting rod connected to the operation portion, the first connecting rod and the second connecting rod are connected to each other through a connecting assembly, the connecting assembly is a foldable assembly, and the connecting assembly is folded so that the connecting rod is folded, causing the power tool to be in a folded state.

In some examples, when the power tool is in the folded state, the uppermost end of the working head away from the axis of the connecting rod is connected to an end of the first connecting rod away from the working head to form a first straight line, and the center of the first handle is located between the first straight line and the first connecting rod.

In some examples, when the power tool is in the folded state, the second connecting rod is located above the first connecting rod.

In some examples, when the power tool is in the folded state, the first straight line, the first connecting rod, and the working head form a triangular region.

In some examples, when the power tool is in the folded state, the height of the operation portion is less than or equal to the height of the working head along an up and down direction perpendicular to the axis of the first connecting rod.

In some examples, a power tool includes: an operation portion including a first handle for the user to grip; a working head drivable to work; a connecting rod connecting the first handle to the working head; and a battery pack configured to power the power tool. The first handle is disposed at the rear end of the connecting rod, and the first handle and the battery pack are disposed on two sides of the connecting rod, respectively.

In some examples, the center of a grip of the first handle is disposed on the upper side of the axis of the connecting rod, and the battery pack is disposed on the lower side of the axis of the connecting rod.

In some examples, a power tool includes: an operation portion including a first handle for the user to grip; a working head drivable to work; a connecting rod connecting the first handle to the working head; and a battery pack configured to power the power tool. The first handle is disposed at the rear end of the connecting rod, and the first handle and the battery pack are disposed vertically along a direction perpendicular to the axis of the connecting rod. The first handle forms a second included angle with the connecting rod, where the second included angle is greater than or equal to 45 degrees and less than or equal to 90 degrees.

In some examples, the first handle further includes a grip trigger, and when the included angle between the connecting rod and the direction in which the power tool is pushed by the user is 45 degrees, the height difference between the central position of the grip trigger and the axis of the connecting rod is less than or equal to 200 mm.

In some examples, the power tool further includes a second handle, where the second handle is disposed between the first handle and the working head, and when the included angle between the power tool and the ground is 45 degrees, the height difference between the central position of the second handle and the central position of the first handle is less than or equal to 200 mm.

### BRIEF DESCRIPTION OF DRAWINGS

FIG. 1 is a perspective view of a snow shovel according to an example;

FIG. 2 is a side view of the snow shovel in FIG. 1;

FIG. 3 is another side view of the snow shovel in FIG. 1 with one side plate removed when a connecting rod forms an angle of 45 degrees with the ground;

FIG. 4 is a side view of the snow shovel in FIG. 1 when a connecting rod forms an angle of 45 degrees with the ground;

FIG. 5 is a side view of the snow shovel in FIG. 1 placed on the ground;

FIG. 6 is a side view of the snow shovel in FIG. 1 with a second handle removed;

FIG. 7 is a side view of the snow shovel in FIG. 1 with a second handle removed and a battery pack folded;

FIG. 8 is a perspective view of the snow shovel in FIG. 1 with a second handle removed and a battery pack folded;

FIG. 9 is a top view of a working head of the snow shovel in FIG. 1 with a housing removed;

FIG. 10 is a rear view of a working head of the snow shovel in FIG. 1;

FIG. 11 is another top view of a working head of the snow shovel in FIG. 1 with a housing removed;

FIG. 12 is a side view of an electric motor of the snow shovel in FIG. 1;

FIG. 13 is a perspective view of part of the snow shovel in FIG. 1;

FIG. 14 is a rear sectional view of a working head of the snow shovel in FIG. 1;

FIG. 15 is a perspective view showing the connection between a working head and a connecting rod of the snow shovel in FIG. 1;

FIG. 16 is a rear sectional view of a connecting rod of the snow shovel in FIG. 1;

FIG. 17 is a side view showing the connection between an operation portion and a connecting rod of the snow shovel in FIG. 1;

FIG. 18 is a side view of the inside of a working head of the snow shovel in FIG. 1;

FIG. 19 is a side view of the standing snow shovel in FIG. 1; and

FIG. 20 is a side view of a standing working head of the snow shovel in FIG. 1.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

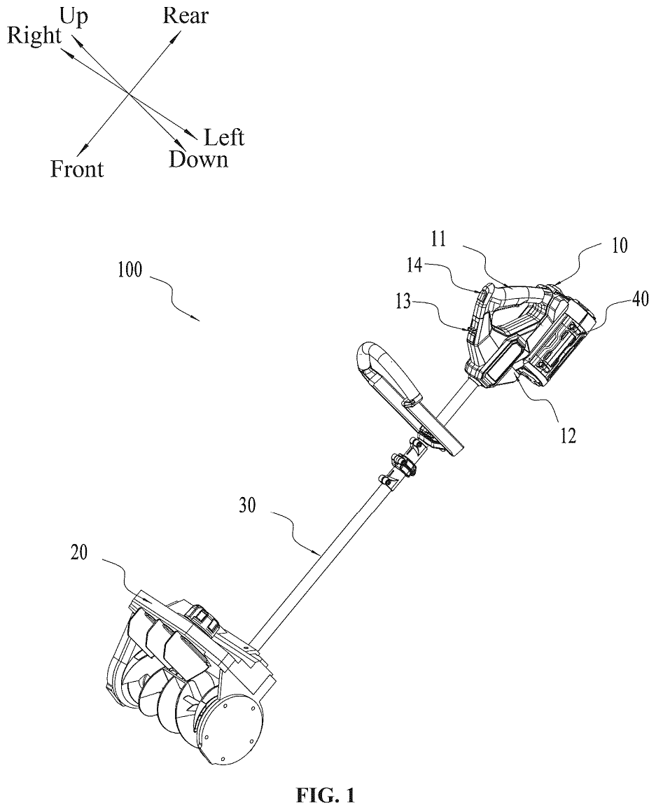

FIG. 1 illustrates a power tool. The power tool may specifically be a pole power tool, for example, a snow shovel 100, a string trimmer, a pruner, pruning shears, or a wall grinder. As an optional example, the snow shovel 100 is described below as an example.

FIG. 1 illustrates a snow shovel 100 for a user to remove snow. The snow shovel 100 includes an operation portion 10, a working head 20, a connecting rod 30, and a battery pack 40. The operation portion 10 includes a first handle 11. The first handle 11 is used as a main handle for the user to grip. The working head 20 is driven to work, for example, to remove snow. The connecting rod 30 connects the first handle 11 to the working head 20. The operation portion 10 further includes a battery pack mounting portion 12 on which the battery pack 40 is mounted. This battery pack 40 is configured to power the snow shovel 100. To facilitate the description of technical solutions, a front side, a rear side, a left side, a right side, an upper side, and a lower side are defined as shown in FIG. 1. The front side, the rear side, the left side, the right side, the upper side, and the lower side are defined based on the connecting rod 30. The connecting rod 30 may be made of aluminum, thereby reducing the overall weight of the snow shovel 100 and making the snow shovel 100 convenient for the user to use.

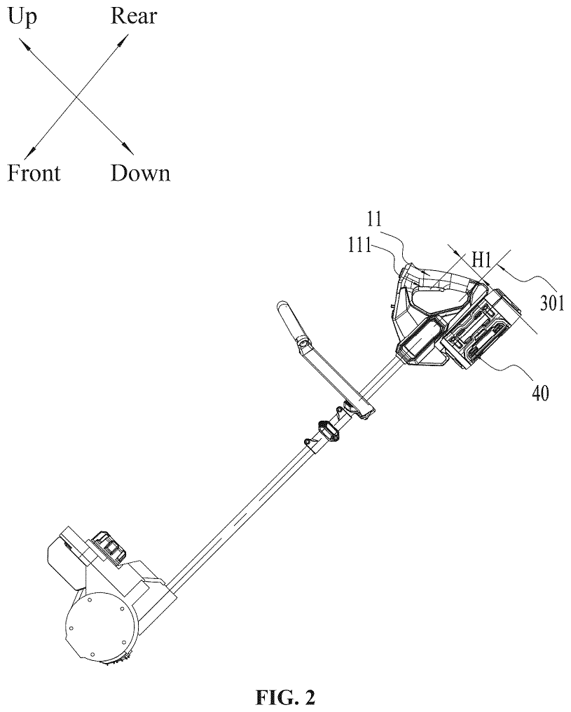

In the example of the present application, as shown in FIG. 1, the first handle 11 is disposed at the rear end of the connecting rod 30. The first handle 11 and the battery pack 40 are disposed vertically along a direction perpendicular to the axis 301 of the connecting rod 30. That is, along the direction perpendicular to the axis 301 of the connecting rod 30, the first handle 11 and the battery pack 40 have a vertical disposing relationship. The first handle 11 is disposed on the upper side of the battery pack 40, or the battery pack 40 is disposed on the upper side of the first handle 11. As shown in FIG. 1, in the example of the present application, specifically, the first handle 11 is disposed on the upper side of the battery pack 40, and the first handle 11 and the battery pack 40 are disposed on two sides of the connecting rod 30 respectively to be connected to the connecting rod 30. As shown in FIG. 2, to facilitate the user's operation, the center of a grip of the first handle 11 is disposed on the upper side of the axis 301 of the connecting rod 30, and the battery pack 40 is disposed on the lower side of the axis 301 of the connecting rod 30. As shown in FIG. 1, the operation portion 10 further includes a speed adjustment assembly 13 configured to adjust a working speed of the snow shovel 100. For example, the snow shovel 100 may have two working speeds: a low speed and a high speed. The speed adjustment assembly 13 is operated so that the working speed of the snow shovel 100 is switched to the low speed or the high speed. In addition, the snow shovel 100 may have multiple working speeds such as a third speed and a fourth speed. The specific number of speeds of the snow shovel 100 is not limited in the present application. As shown in FIG. 1, the operation portion 10 further includes a switch assembly 14 configured to control the start or stop of the snow shovel 100. Both the speed adjustment assembly 13 and the switch assembly 14 are disposed on the operation portion 10 so that it is convenient for the user to control the start and stop of the snow shovel 100 while gripping the first handle 11 and adjust the working speed of the snow shovel 100 at any time. In addition, as shown in FIG. 2, a D-shaped space is formed at the position in the operation portion 10 for the user to grip and is in accord with the shape of the hand of the user gripping the first handle 11.

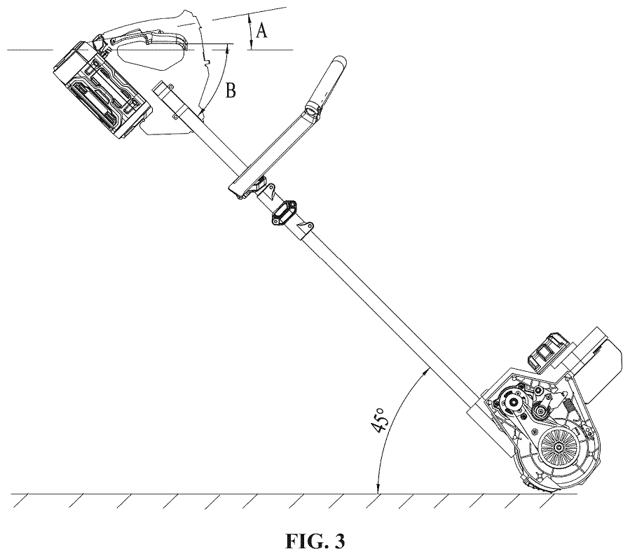

As shown in FIG. 3, when the user uses the snow shovel 100 and the included angle between the axis of the connecting rod 30 and a walking direction of the power tool is 45 degrees, an extension direction of the first handle 11 forms a first included angle A with the walking direction of the power tool. The walking direction is the direction the working head 20 moves towards when the operation portion 10 is pushed by a user. The extension direction of the first handle 11 refers to the centerline of the handle 11. The first included angle A is greater than or equal to 30 degrees and less than or equal to 90 degrees. Optionally, the first included angle A is 35 degrees. Optionally, the first included angle A is 45 degrees. Optionally, the first included angle A is 60 degrees. As shown in FIG. 3, the first handle 11 forms a second included angle B with the connecting rod 30. In other words, the second included angle B is between a lower edge of the first handle 11 and the axis 301 of the connecting rod 30. The second included angle B is greater than or equal to 45 degrees and less than or equal to 90 degrees. Optionally, the second included angle B is 50 degrees. Optionally, the second included angle B is 60 degrees. Optionally, the second included angle B is 75 degrees. As shown in FIG. 2, the first handle 11 further includes a grip trigger 111. The grip trigger 111 is specifically gripped by the user when the snow shovel 100 is used. In an up and down direction, the height difference H1 between the central position of the grip trigger 111 and the axis 301 of the connecting rod 30 is less than or equal to 200 mm. In addition, the central position of the grip trigger 111 may be disposed below the axis 301 of the connecting rod 30. In this case, the height difference H1 between the central position of the grip trigger 111 and the axis 301 of the connecting rod 30 is less than or equal to 50 mm. That is, the central position of the grip trigger 111 may be below the axis 301 of the connecting rod 30, the grip trigger 111 is at least partially disposed below the axis 301 of the connecting rod 30, and the range of the central position of the grip trigger 111 below the axis 301 of the connecting rod 30 does not exceed 50 mm. Alternatively, the central position of the grip trigger 111 may be parallel to the axis 301 of the connecting rod 30 or may be disposed above the axis 301 of the connecting rod 30, and the range of the central position of the grip trigger 111 above the axis 301 of the connecting rod 30 does not exceed 200 mm. That is, the grip trigger 111 is at least partially disposed above the axis 301 of the connecting rod 30 and is parallel to the axis 301 of the connecting rod 30. The included angle between the first handle 11 and the direction in which the power tool is pushed by the user, the included angle between the first handle 11 and the connecting rod 30, and the height difference H1 between the axis 301 of the connecting rod 30 and the grip trigger 111 which is specifically gripped by the user when using the snow shovel 100 are configured, which each allow the user to push the snow shovel 100 with less effort. Thus, it is more convenient for the user to push and use the snow shovel 100.

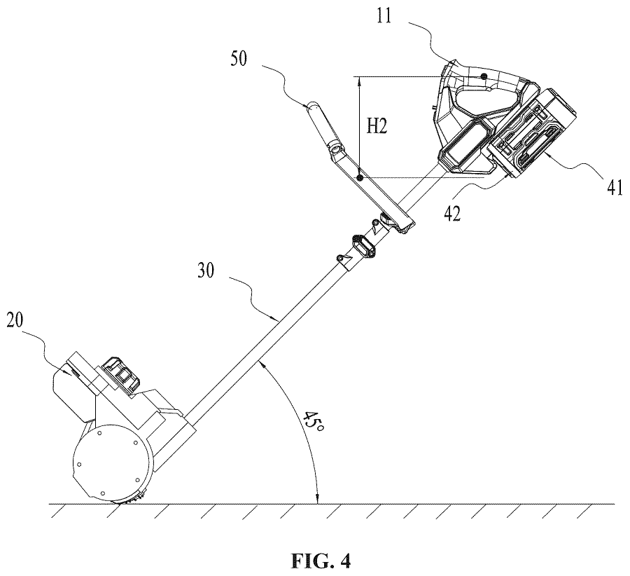

In some examples, a second handle 50 is further disposed on the snow shovel 100 and is used as an auxiliary handle. The second handle 50 is disposed between the first handle 11 and the working head 20 and disposed on the connecting rod 30. To facilitate the user's operation, like the first handle 11, the second handle 50 is also disposed on the upper side of the connecting rod 30. When using the snow shovel 100, the user can grip both the first handle 11 and the second handle 50 simultaneously. As shown in FIG. 4, when the included angle between the snow shovel 100 and the ground is 45 degrees, the height difference H2 between the central position of the first handle 11 and the central position of the second handle 50 is less than or equal to 200 mm. That is, in a direction perpendicular to the ground, the range of the central position of the second handle 50 below the central position of the first handle 11 is less than or equal to 200 mm. Thus, when the user uses the snow shovel 100, it is convenient for the user to grip both the first handle 11 and the second handle 50 simultaneously.

In some examples, lighting devices are mounted on the first handle 11 and/or the second handle 50. Thus, when the snow shovel 100 is used at night or in the dark, the lighting devices can assist the user in clearly seeing the operation portion 10 for operation and assist the user in clearly seeing a road surface so that it is convenient for the user to use the snow shovel 100. A respective one of the lighting devices may be disposed at any position on the first handle 11 or the second handle 50. The positions of the lighting devices are not limited in the present application. Optionally, the lighting devices may be powered by the battery pack 40. Optionally, the lighting devices may be lighting devices that can store electricity. After being charged through an external power supply, the lighting devices are mounted on the first handle 11 and/or the second handle 50. Optionally, the lighting devices may be powered in other manners. The manner in which the lighting devices are powered is not limited in the present application.

In some examples, the battery pack 40 is detachably connected to the connecting rod 30. The battery pack 40 is mounted to the connecting rod 30 along a direction parallel to the connecting rod 30. That is, the battery pack 40 is mounted on the battery pack mounting portion 12 of the operation portion 10 along the direction parallel to the connecting rod 30 and disposed on the lower side of the connecting rod 30. The battery pack 40 is parallel to the connecting rod 30. As shown in FIG. 4, the battery pack 40 has a first length 41 parallel to the connecting rod 30 and a second length 42 perpendicular to the connecting rod 30. The first length 41 is greater than the second length 42. That is, a relatively small surface of the battery pack 40 is mounted to the battery pack mounting portion 12, and a relatively large surface of the battery pack 40 is parallel to the connecting rod 30. Since the relatively large surface of the battery pack 40 is parallel to the connecting rod 30 and the battery pack 40 is in direct contact with the connecting rod 30, the center of gravity of the battery pack 40 is higher than the central position of the connecting rod 30. Thus, the gravity of the battery pack 40 can be shared by the connecting rod 30. Thus, when the user pushes the snow shovel 100, at least part of the weight of the battery pack 40 is distributed on the connecting rod 30. That is, the weight of the battery pack 40 can be distributed along the connecting rod 30 so that the force exerted on the user's hands is reduced during the use of the snow shovel 100.

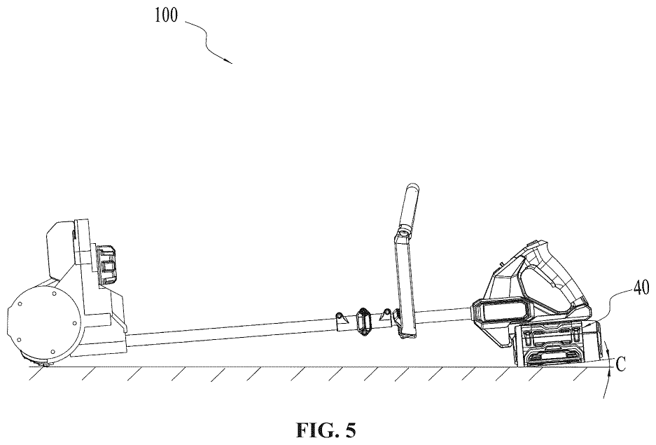

As shown in FIG. 5, when the snow shovel 100 is placed on the ground with the working head 20 and the battery pack 40 both on the ground, the battery pack 40 forms a third included angle C with the ground. The included angle C is between a lower edge of the battery pack 40 and the ground. The third included angle C is less than or equal to 30 degrees. Since the included angle between the battery pack 40 and the ground is relatively small, a relatively large area on the battery pack 40 is in contact with the ground. Thus, when the user stops using the snow shovel 100 and releases it, the battery pack 40 is less likely to impact the ground and be damaged.

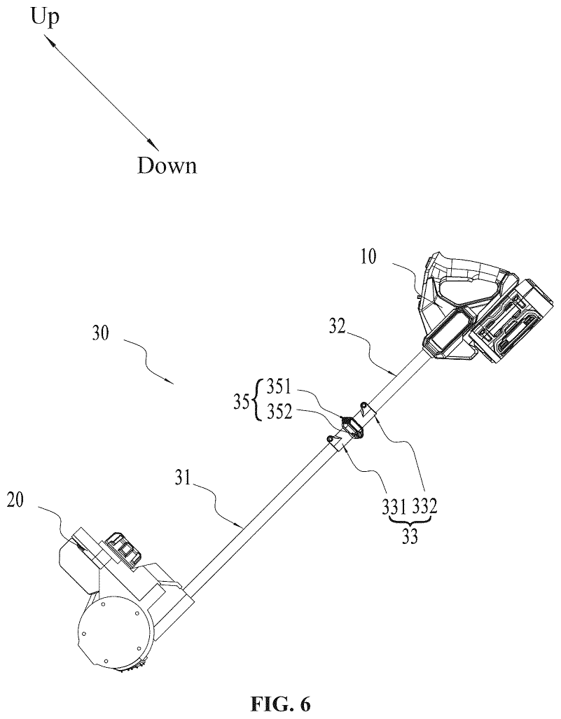

In some examples, as shown in FIG. 6, the connecting rod 30 includes a first connecting rod 31 and a second connecting rod 32. The first connecting rod 31 and the second connecting rod 32 are connected to each other through a connecting assembly 33 to form the connecting rod 30. The first connecting rod 31 is connected to the working head 20, and the second connecting rod 32 is connected to the operation portion 10. The connecting assembly 33 is foldable. Thus, the connecting assembly 33 is folded so that the connecting rod 30 is folded, causing the snow shovel 100 to be in a folded state. Optionally, the snow shovel shown in FIG. 6 may be the snow shovel 100 shown in FIG. 1 with the second handle 20 removed. Optionally, the snow shovel shown in FIG. 6 may be a snow shovel in another example.

Optionally, both the first connecting rod 31 and the second connecting rod 32 may be linear connecting rods. That is, the connecting rod 30 is a linear connecting rod. Then, the axis 301 of the connecting rod 30 is a linear axis. Optionally, the connecting rod 30 may be constituted by a curved connecting rod and a linear connecting rod, and the axis 301 of the connecting rod 30 may include a curved axis and a linear axis. The portion of the connecting rod 30 connected to the operation portion 10 is the linear connecting rod while the portion of the connecting rod 30 connected to the working head 20 is the curved connecting rod. That is, the second connecting rod 32 may be the linear connecting rod, and the first connecting rod 31 may be the curved connecting rod. In the present application, the axis 301 of the connecting rod 30 may be linear or may be partially linear. The linear connecting rod 30 is used as an example for description in the present application.

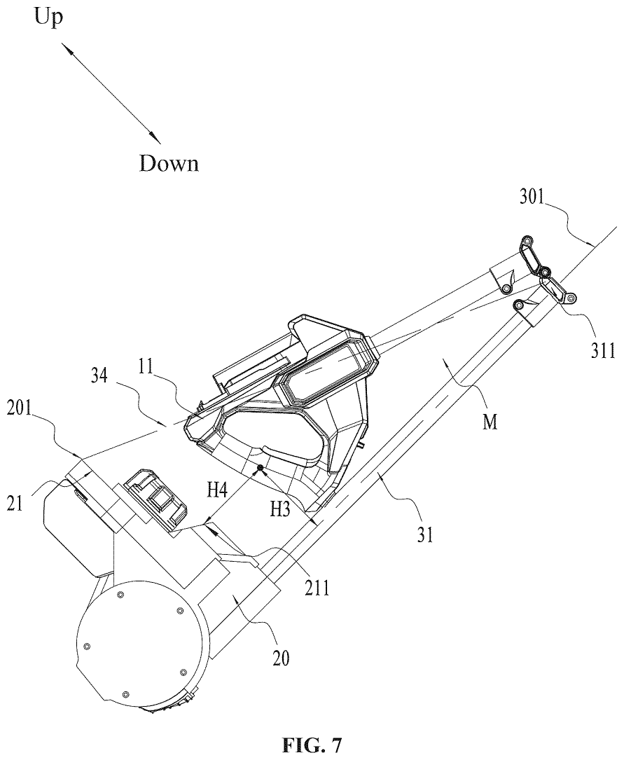

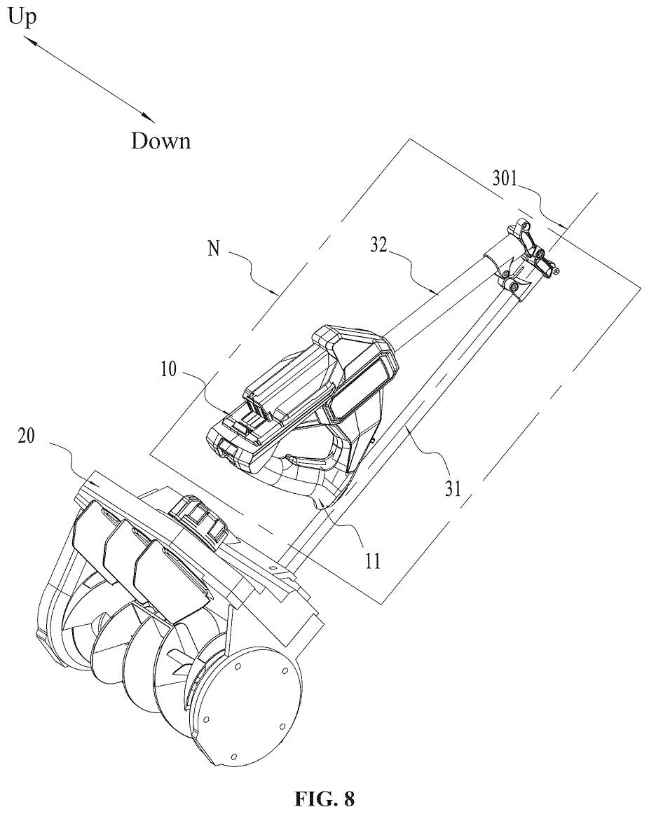

As shown in FIG. 7, when the snow shovel 100 is in the folded state, the uppermost end 201 of the working head 20 away from the axis 301 of the connecting rod 30 is connected to an end 311 of the first connecting rod 31 away from the working head 20 to form a first straight line 34. That is, the uppermost end 201 of the working head 20 in the direction perpendicular to the axis 301 of the connecting rod 30 is connected to the end 311 of the first connecting rod 31 that is not connected to the working head 20 such that the first straight line 34 is formed. As shown in FIG. 7, the center of the first handle 11 is located between the first straight line 34 and the first connecting rod 31. The first straight line 34, the first connecting rod 31, and the working head 20 form a triangular region M. The center of the first handle 11 is located within this triangular region M. To ensure that the center of the first handle 11 is located within the triangular region M, that is, the first handle 11 is not located above the working head 20 after being folded, As shown in FIG. 8, a preset projection of the second connecting rod 32 and the operation portion 10 is formed on a plane N parallel to the axis 301 of the connecting rod 30 and perpendicular to the working head 20. Additionally, the length of the first connecting rod 31 is greater than or equal to the length of this preset projection.

As shown in FIG. 7, when the snow shovel 100 is in the folded state, the distance H3 between the center of the first handle 11 and the axis 301 of the first connecting rod 31 is less than or equal to 270 mm. Optionally, the first handle 11 may abut against the first connecting rod 31. The first handle 11 is in contact with the first connecting rod 31. In this case, the distance between the center of the first handle 11 and the axis 301 of the first connecting rod 31 is minimized. Optionally, the first handle 11 may not be in contact with the first connecting rod 31 and the first handle 11 is located above the first connecting rod 31 as long as the center of the first handle 11 only needs to be located within the triangular region M. Optionally, when the distance between the center of the first handle 11 and the axis 301 of the first connecting rod 31 is 105 mm, the first handle 11 is the closest to the first connecting rod 31. That is, in this case, the first handle 11 is in contact with the first connecting rod 31. Optionally, when the distance between the center of the first handle 11 and the axis 301 of the first connecting rod 31 is 270 mm, the first handle 11 is the farthest from the first connecting rod 31. That is, the center of the first handle 11 is at the edge of the triangular region M and on the first straight line 34.

As shown in FIG. 8, when the snow shovel 100 is in the folded state, the second connecting rod 32 is located above the first connecting rod 31. That is, the second connecting rod 32 is folded toward the upper side of the connecting rod 30, thereby folding the snow shovel 100. In this case, as shown in FIG. 7, the distance H4 between the center of the first handle 11 and a preset position 211 on a housing 21 of the working head 20 is less than or equal to 200 mm. The connecting line from the preset position 211 on the housing 21 of the working head 20 to the center of the first handle 11 is parallel to the axis 301 of the first connecting rod 31. Optionally, the first handle 11 may abut against the working head 20. The first handle 11 is in contact with the housing 21 of the working head 20. Optionally, the first handle 11 may not be in contact with the housing 21 of the working head 20. The snow shovel 100 is folded so that the snow shovel 100 can have a relatively small volume. Thus, it is convenient to store and carry the snow shovel 100. In addition, the snow shovel 100 is folded toward the upper side of the connecting rod 30 in this example, and thus, the folded snow shovel 100 has a smaller volume than that of the snow shovel 100 folded in other manners. Furthermore, to minimize the volume of the folded snow shovel 100, the first handle 11 may be caused to abut against the first connecting rod 31.

In some examples, when the snow shovel 100 is in the folded state, the height of the operation portion 10 is less than or equal to the height of the working head 20 along the up and down direction perpendicular to the axis 301 of the first connecting rod 31. Thus, the volume of the folded snow shovel 100 is further reduced.

In some examples, as shown in FIG. 6, the connecting assembly 33 includes a first connecting assembly 331 and a second connecting assembly 332. The first connecting assembly 331 is sleeved on the first connecting rod 31. The second connecting assembly 332 is sleeved on the second connecting rod 32. The first connecting assembly 331 and the second connecting assembly 332 are connected to each other through at least two sets of fixing assemblies 35 to form the connecting assembly 33. The two sets of fixing assemblies 35 include a first set of fixing assemblies 351 and a second set of fixing assemblies 352. The first set of fixing assemblies 351 is disposed on the first connecting rod 31. The second set of fixing assemblies 352 is disposed under the first connecting rod 31. The first set of fixing assemblies 351 is rotatable. Thus, after the second set of fixing assemblies 352 is removed, the second connecting rod 32 or the first connecting rod 31 is rotated based on the first set of fixing assemblies 351 to fold the connecting rod 30. The second connecting rod 32 may be rotated upward in a counterclockwise direction or the first connecting rod 31 may be rotated upward in a clockwise direction so that the connecting rod 30 is folded. Optionally, three sets of fixing assemblies 35 may be provided. Two of the three sets of fixing assemblies 35 are fixed under the first connecting rod 31. One of the three sets of fixing assemblies 35 is fixed on the first connecting rod 31. The set of fixing assemblies 35 fixed on the first connecting rod 31 is rotatable. Optionally, four sets of fixing assemblies 35 may be provided. Three of the four sets of fixing assemblies 35 are fixed under the first connecting rod 31. One of the four sets of fixing assemblies 35 is fixed on the first connecting rod 31. The set of fixing assemblies 35 fixed on the first connecting rod 31 is rotatable. In addition, other numbers of multiple sets of fixing assemblies 35 may be provided, which is not limited in the present application. The set of fixing assemblies fixed on the first connecting rod 31 is always one set of rotatable fixing assemblies.

In some examples, a connecting wire between the working head 20 and the operation portion 10 is disposed within the connecting rod 31. The connecting wire passes through the connecting rod 31 to connect the working head 20 to the operation portion 10. Thus, the snow shovel 100 is folded so that the connecting wire is prevented from being pulled and damaged during the disassembly of the snow shovel 100.

In some examples, when the snow shovel 100 is folded, the battery pack 40 and the second handle 50 may be removed so that the folded snow shovel 100 has a smaller volume. As shown in FIG. 8, when the snow shovel 100 is in the folded state, two sides of the first handle 11 can form accommodation spaces with the working head 20 because the volume of the working head 20 is larger than that of the operation portion 10. The battery pack 40 and the second handle 50 may be placed in the accommodation spaces on the two sides, respectively. Thus, when the snow shovel 100 is stored, the overall volume of the snow shovel 100 to be stored is smaller, and all components of the snow shovel 100 can be stored.

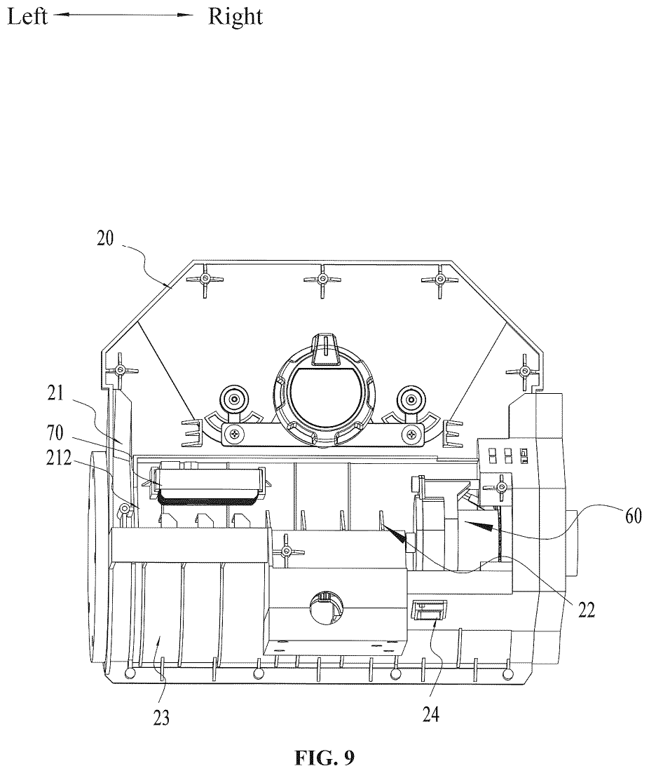

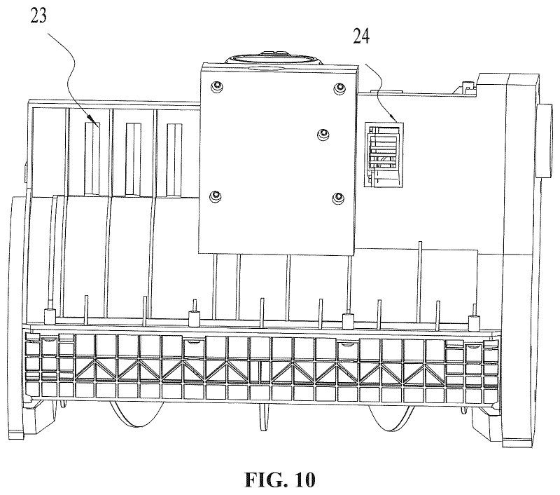

As shown in FIG. 9, the working head 20 includes a housing 21 and an auger 22. The housing 21 is formed with an accommodation space 212. The snow shovel 100 includes an electric motor 60 and a circuit board 70. Both the electric motor 60 and the circuit board 70 are disposed in the accommodation space 212. The electric motor 60 is configured to drive the auger 22. The circuit board 70 is configured to control the running of the electric motor 60. As shown in FIG. 10, the snow shovel 100 also includes a heat dissipation airflow inlet 23 and a heat dissipation airflow outlet 24. The heat dissipation airflow inlet 23 causes the inside and outside of the accommodation space 212 to communicate with each other. The heat dissipation airflow outlet 24 also causes the inside and outside of the accommodation space 212 to communicate with each other. The shapes or structures of the heat dissipation airflow inlet 23 and the heat dissipation airflow outlet 24 are not limited in the present application. Any shape or structure that allows an airflow to circulate is acceptable. Thus, when the snow shovel 100 is in operation, the user pushes the snow shovel 100 back and forth. Therefore, a heat dissipation airflow can enter through the heat dissipation airflow inlet 23, flow through the circuit board 70 and the electric motor 60, and exit through the heat dissipation airflow outlet 24. Thus, the circuit board 70 and the electric motor 60 are cooled down through the heat dissipation airflow during the use of the snow shovel 100, thereby solving the problem that the circuit board 70 and the electric motor 60 are at excessively high temperatures when in operation for a long period of time. Therefore, compared with the previous snow shovel 100 with the circuit board 70 and the electric motor 60 disposed in the operation portion 10, the present application causes the circuit board 70 and the electric motor 60 to be disposed in the working head 20. Thus, the circuit board 70 and the electric motor 60 can be prevented from an overtemperature, thereby prolonging their service lives and reducing the costs of long-term use of the snow shovel 100. Moreover, the circuit board 70 and the electric motor 60 are disposed in the working head 20, thereby avoiding an excessive weight of the operation portion 10. The weight of the operation portion 10 is reduced, which allows the user to push the snow shovel 100 with less effort. Optionally, the working head of the snow shovel shown in FIG. 9 may be the working head 20 of the snow shovel 100 shown in FIG. 1 or may be the working head of a snow shovel in another example.

In some examples, as shown in FIG. 9, the circuit board 70 is disposed on a first side of the accommodation space 212, and the heat dissipation airflow inlet 23 corresponds to the circuit board 70 and is also provided on the first side of the accommodation space 212. The electric motor 60 is disposed on the second side of the accommodation space 212, and the heat dissipation airflow outlet 24 corresponds to the electric motor 60 and is also provided on the second side of the accommodation space 212. When the left side of the accommodation space 212 is defined as the first side, the second side is the right side of the accommodation space 212. When the right side of the accommodation space 212 is defined as the first side, the second side is the left side of the accommodation space 212. The present application does not define the first side or the second side as a specific side of the accommodation space 212 as long as the heat dissipation airflow inlet 23 and the circuit board 70 are on the same side and the heat dissipation airflow outlet 24 and the electric motor 60 are on the same side.

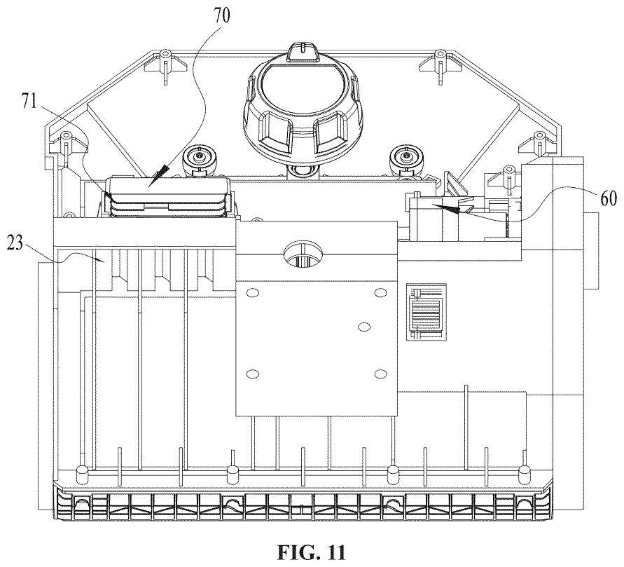

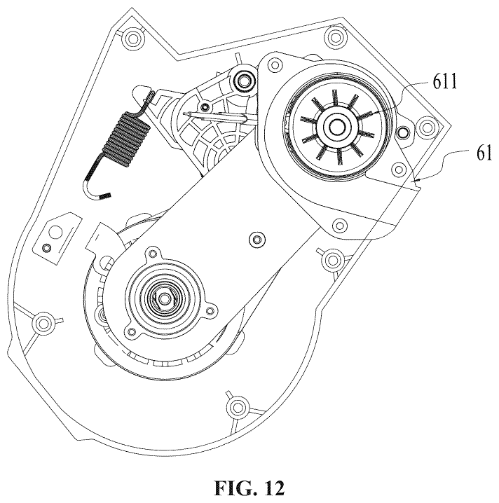

In some examples, as shown in FIG. 11, to facilitate better heat dissipation for the circuit board 70, a heat sink 71 is disposed on the circuit board 70. Optionally, the heat dissipation airflow enters through the heat dissipation airflow inlet 23, passes through the heat sink 71 on the circuit board 70, and then flows toward the electric motor 60. Optionally, as shown in FIG. 12, the electric motor 60 is disposed in a heat dissipation assembly 61 for an electric motor. The heat dissipation assembly 61 for the electric motor is an independent volute. The heat dissipation assembly 61 for the electric motor may have a smooth Archimedean spiral-like shape. Thus, when flowing from the circuit board 70 to the electric motor 60, the heat dissipation airflow passes through the heat dissipation assembly 61 for the electric motor to flow through the electric motor 60 and exits through an outlet of the heat dissipation assembly 61 for the electric motor. The outlet of the heat dissipation assembly 61 for the electric motor is connected to the heat dissipation airflow outlet 24 so that the heat dissipation airflow can directly exit from the snow shovel 100. Optionally, a fan 611 is disposed in the heat dissipation assembly 61 for the electric motor. The fan 611 is connected to the electric motor 60. The electric motor 60 runs to drive the fan 611 to rotate. Thus, when the electric motor 60 runs, the rotating fan 611 can drive the heat dissipation airflow to flow from the circuit board 70 to the heat dissipation assembly 61 for the electric motor and exit from the heat dissipation assembly 61 for the electric motor. In addition, the rotating fan 611 can also drive the heat dissipation airflow to enter from the heat dissipation airflow inlet 23 and flow through the circuit board 70. The heat dissipation assembly 61 for the electric motor is configured to have a smooth Archimedean spiral-like shape so that the heat dissipation airflow can fully circulate around the electric motor 60 before exiting. Thus, the heat dissipation effect of the electric motor 60 is enhanced, thereby improving the efficiency of the electric motor 60. The service life of the electric motor 60 is further prolonged, and the costs of the long-term use of the snow shovel 100 are further reduced.

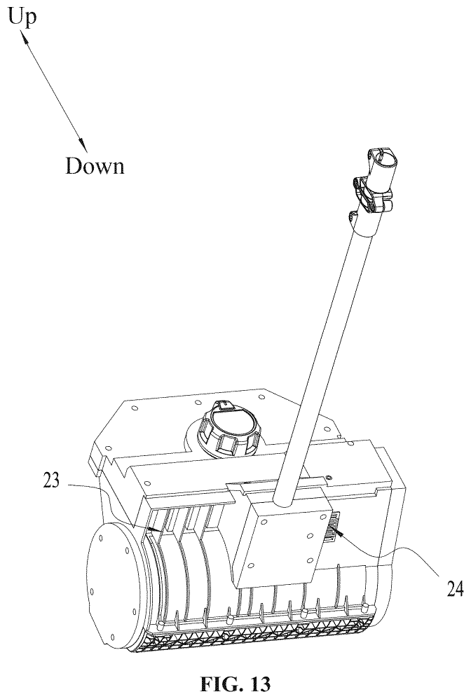

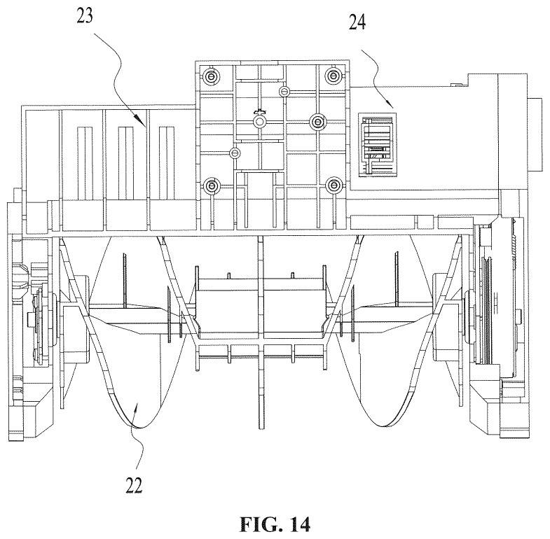

As shown in FIG. 13, both the heat dissipation airflow inlet 23 and the heat dissipation airflow outlet 24 face downward. Thus, when the user uses the snow shovel 100, the airflow generated by the user pushing the snow shovel 100 facilitates the entrance and exit of the heat dissipation airflow. The auger 22 is also disposed in the accommodation space 212. Optionally, as shown in FIG. 14, both the heat dissipation airflow inlet 23 and the heat dissipation airflow outlet 24 are provided above the auger 22. Optionally, the heat dissipation airflow inlet 23 and the heat dissipation airflow outlet 24 may be provided in other directions of the auger 22, which is not limited in the present application. With respect to the direction of the snow shovel 100 (that is, along the direction of the connecting rod 30), both the heat dissipation airflow inlet 23 and the heat dissipation airflow outlet 24 are provided behind the auger 22.

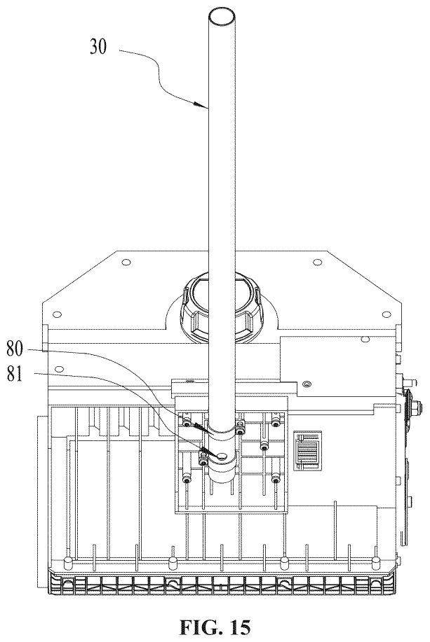

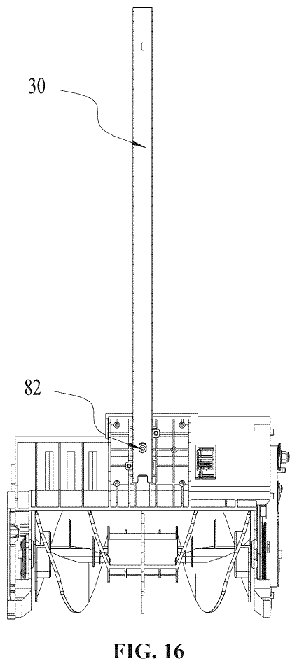

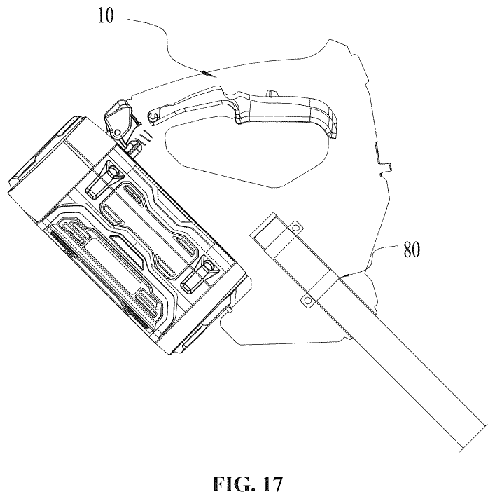

In some examples, since the circuit board 70 and the electric motor 60 are both disposed in the working head 20, the connecting rod 30 is fixedly connectable to both the working head 20 and the operation portion 10. As shown in FIGS. 15 and 16, the connecting rod 30 may be fixed to the working head 20 through two hoops 80. In addition, the connecting rod 30 may be fixed to the working head 20 through other numbers of hoops 80. The number of hoops 80 is not limited in the present application. To avoid the case where the connecting rod 30 moves up and down after being fixed to the working head 20, that is, the connecting rod 30 moves back and forth along the snow shovel 100 and to avoid the rotation of the connecting rod 30, at least one limit hole 81 may be provided on the connecting rod 30, and a limit hole mating assembly 82 may be disposed on the working head 20 to mate with the limit hole 81. Similarly, as shown in FIG. 17, the connecting rod 30 may also be fixed to the operation portion 10 through two hoops 80. In addition, the connecting rod 30 may also be fixed to the operation portion 10 through other numbers of hoops 80. The number of hoops 80 is not limited in the present application. Similarly, a limit hole 81 and a limit hole mating assembly 82 may mate with each other such that the connecting rod 30 is prevented from rotating or moving relative to the operation portion 10. The details are not repeated here. The connecting rod 30 is fixed to the working head 20 and the operation portion 10 through loops 80 so that the connecting rod 30 generates no noise during the use of the snow shovel 100. Optionally, the manner in which the working head and the connecting rod of the snow shovel are connected to each other shown in FIGS. 15 and 16 may be the manner in which the working head 20 and the connecting rod 30 of the snow shovel 100 are connected to each other shown in FIG. 1 or may be the manner in which the working head and the connecting rod of a snow shovel are connected to each other in another example.

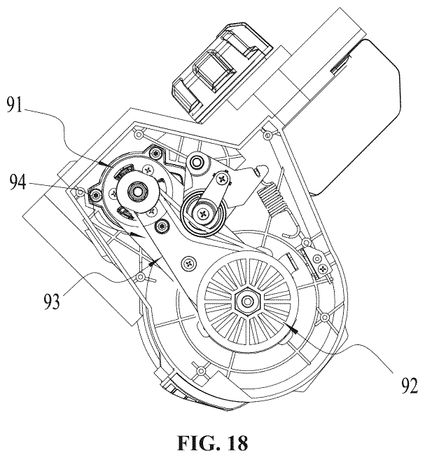

In some examples, to enable the electric motor 60 to drive the auger 22 to work, a first pulley 91 is connected to the electric motor 60, a second pulley 92 is connected to the rotation shaft of the auger 22, and the first pulley 91 and the second pulley 92 are connected to each other through multiple belts 93. The first pulley 91 is smaller than the second pulley 92. A height difference may occur between the first pulley 91 and the second pulley 92 after the long-term use of the snow shovel 100, causing the snow shovel 100 to be incapable of working normally. To avoid the case described above, as shown in FIG. 18, a fixing plate 94 is disposed in the working head 20. The first pulley 91 and the second pulley 92 are mounted at two ends of the fixing plate 94, respectively. Thus, the first pulley 91 and the second pulley 92 are always maintained at the same height through the fixing plate 94. Thus, the service lives of the two pulleys are prolonged, and it is ensured that the snow shovel 100 works normally.

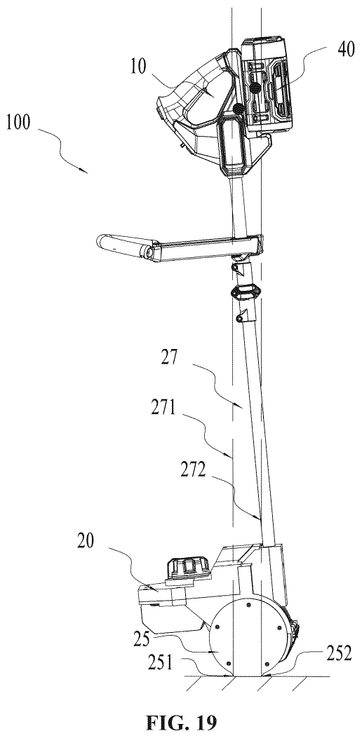

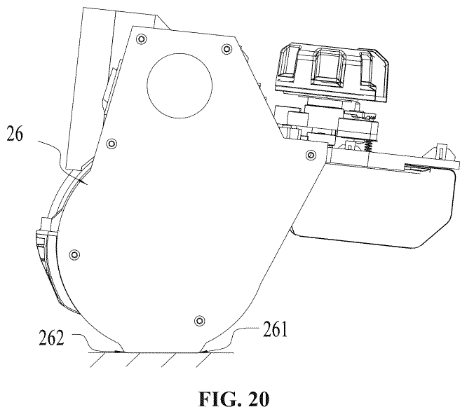

In some examples, as shown in FIGS. 19 and 20, the working head 20 further includes a first side plate 25 and a second side plate 26. The first side plate 25 and the second side plate 26 are the left and right side plates of the working head 20, respectively. The first side plate 25 includes a first contact point 251 and a second contact point 252. The second side plate 26 includes a third contact point 261 and a fourth contact point 262. The snow shovel 100 is supported by the first contact point 251, the second contact point 252, the third contact point 261, and the fourth contact point 262 to stand. When the snow shovel 100 stands, the center of gravity of the operation portion 10 and the center of gravity of the battery pack 40 are both within a center of gravity range 27 defined by the first contact point 251 and the second contact point 252. The range between a first center of gravity plane 271 and a second center of gravity plane 272 is defined as the center of gravity range 27. The first center of gravity plane 271 is a plane that is perpendicular to the connecting line from the first contact point 251 to the second contact point 252 and passes through the first contact point 251. The second center of gravity plane 272 is a plane that is perpendicular to the connecting line from the first contact point 251 to the second contact point 252 and passes through the second contact point 252. Thus, since the center of gravity of the operation portion 10 and the center of gravity of the battery pack 40 are both within the center of gravity range 27, the snow shovel 100 can stand stably.

In some examples, the connecting line from the first contact point 251 to the third contact point 261 is parallel to the connecting line from the second contact point 252 to the fourth contact point 262. Thus, the first center of gravity plane 271 may be a plane that is perpendicular to the connecting line from the first contact point 251 to the second contact point 252 and passes through the third contact point 261, and the second center of gravity plane 272 may be a plane that is perpendicular to the connecting line from the first contact point 251 to the second contact point 252 and passes through the fourth contact point 262. Optionally, the standing manner of the snow shovel shown in FIG. 19 may be the standing manner of the snow shovel 100 shown in FIG. 1 or may be the standing manner of a snow shovel in another example.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
an operation portion comprising a first handle for a user to grip;
a working head drivable to work;
a connecting rod connecting the first handle to the working head; and
a battery pack configured to power the power tool;
wherein the first handle is disposed at a rear end of the connecting rod, the first handle and the battery pack are disposed vertically along a direction perpendicular to an axis of the connecting rod, when an included angle between the axis of the connecting rod and a walking direction of the power tool is 45 degrees, an extension direction of the first handle forms a first included angle with the walking direction of the power tool, and the first included angle is greater than or equal to 30 degrees and less than or equal to 90 degrees.

2. The power tool according to claim 1, wherein a lower edge of the first handle forms a second included angle with the axis of the connecting rod, and the second included angle is greater than or equal to 45 degrees and less than or equal to 90 degrees.

3. The power tool according to claim 1, wherein the first handle further comprises a grip trigger, and a height difference between a central position of the grip trigger and the axis of the connecting rod is less than or equal to 200 mm.

4. The power tool according to claim 1, wherein a center of a grip of the first handle is disposed on an upper side of the axis of the connecting rod, and the battery pack is disposed on a lower side of the axis of the connecting rod.

5. The power tool according to claim 1, wherein the battery pack is detachably connected to the connecting rod and is mounted to the connecting rod along a direction parallel to the connecting rod.

6. The power tool according to claim 5, wherein the battery pack has a first length parallel to the connecting rod and a second length perpendicular to the connecting rod, and the first length is greater than the second length.

7. The power tool according to claim 1, further comprising a second handle disposed on an upper side of the connecting rod.

8. The power tool according to claim 7, wherein the second handle is disposed between the first handle and the working head, and, when the included angle between the axis of the connecting rod and the walking direction of the power tool is 45 degrees, a height difference between a central position of the second handle and a central position of the first handle is less than or equal to 200 mm.

9. The power tool according to claim 1, wherein the operation portion further comprises a speed adjustment assembly configured to adjust a working speed of the power tool.

10. The power tool according to claim 1, wherein, when the power tool is placed on the ground with the working head and the battery pack both touching the ground, the battery pack forms a third included angle with the ground, and the third included angle is less than or equal to 30 degrees.

11. The power tool according to claim 1, wherein the connecting rod comprises a first connecting rod connected to the working head and a second connecting rod connected to the operation portion, the first connecting rod and the second connecting rod are connected to each other through a connecting assembly, the connecting assembly is a foldable assembly, and the connecting assembly is folded so that the connecting rod is folded, causing the power tool to be in a folded state.

12. The power tool according to claim 11, wherein, when the power tool is in the folded state, an uppermost end of the working head away from the axis of the connecting rod is connected to an end of the first connecting rod away from the working head to form a first straight line, and a center of the first handle is located between the first straight line and the first connecting rod.

13. The power tool according to claim 11, wherein, when the power tool is in the folded state, the second connecting rod is located above the first connecting rod.

14. The power tool according to claim 12, wherein, when the power tool is in the folded state, the first straight line, the first connecting rod, and the working head form a triangular region.

15. The power tool according to claim 11, wherein, when the power tool is in the folded state, a height of the operation portion is less than or equal to a height of the working head along an up and down direction perpendicular to the axis of the first connecting rod.

16. A power tool, comprising:
an operation portion comprising a first handle for a user to grip;
a working head drivable to work;
a connecting rod connecting the first handle to the working head; and
a battery pack configured to power the power tool;
wherein the first handle is disposed at a rear end of the connecting rod, and the first handle and the battery pack are disposed vertically along a direction perpendicular to an axis of the connecting rod.

17. The power tool according to claim 16, wherein a center of a grip of the first handle is disposed on an upper side of an axis of the connecting rod, and the battery pack is disposed on a lower side of the axis of the connecting rod.

18. A power tool, comprising:
an operation portion comprising a first handle for a user to grip;
a working head drivable to work;
a connecting rod connecting the first handle to the working head; and
a battery pack configured to power the power tool;
wherein the first handle is disposed at a rear end of the connecting rod, the first handle and the battery pack are disposed vertically along a direction perpendicular to an axis of the connecting rod, a lower edge of the first handle forms a second included angle with the axis of the connecting rod, and the second included angle is greater than or equal to 45 degrees and less than or equal to 90 degrees.

19. The power tool according to claim 18, wherein the first handle further comprises a grip trigger, and, when an included angle between the axis of the connecting rod and a walking direction of the power tool is 45 degrees, a height difference between a central position of the second handle and a central position of the first handle is less than or equal to 200 mm.

20. The power tool according to claim 18, further comprising a second handle, wherein the second handle is disposed between the first handle and the working head, and, when the included angle between the axis of the connecting rod and the walking direction of the power tool is 45 degrees, a height difference between a central position of the second handle and a central position of the first handle is less than or equal to 200 mm.
